(19) United States
(12) Patent Application Publication
(10) Pub. No.: US 2008/0128533 A1
(43) Pub. Date: Jun. 5, 2008

(54) FLUID RESERVOIR FOR A PAINT SPRAY GUN

(76) Inventor: Ralf GEHRUNG, Stuttgart (DE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/949,122

(22) Filed: Dec. 3, 2007

(30) Foreign Application Priority Data
Dec. 5, 2006 (DE) 10 2006 057 621.7

(51) Int. Cl. B05B 7/24

(52) U.S. Cl. 239/348

(57) ABSTRACT

The invention relates to a fluid reservoir for a paint spray gun with a container (1) and a cover (2) that is attachable on this container and has a connection part (3) to enable attaching the fluid reservoir on the paint spray gun or on an adapter, wherein the container (1) has a ventilation opening (6) that can be closed by means of a valve (5). In a fluid reservoir known from the state of the art, the valve is constructed in the form of a sliding valve. Here, there is the risk that the ventilation opening is not completely closed if the slide of the sliding valve has not been pushed completely into the valve housing. In order to provide a fluid reservoir with a valve that can be easily actuated manually and that can be closed reliably, it is provided for the fluid reservoir according to the invention that the valve (5) has a closing element (8) that can pivot like a rocker about a pivot axis (7) for closing the ventilation opening (6) in a fluid-tight way.

### CROSS REFERENCE TO RELATED APPLICATION

This application claims priority under 35 U.S.C. §119 to German Patent Application No. 10 2006 057 621.7 filed Dec. 5, 2006, the entire contents of which are incorporated herein by reference.

### FIELD OF THE INVENTION

The invention relates to a fluid reservoir for a paint spray gun.

### BACKGROUND OF THE INVENTION

Such a fluid reservoir is known from the state of the art, for example, from WO 98/32539. This fluid reservoir is provided for one-time use and comprises a container made from plastic and a cover that can be set on top for closing this container. On the top side of the cover there are connection means for the placement and attachment of the fluid reservoir on a paint spray gun or an adapter attached to this gun. In this way, the fluid reservoir is set “upside-down” on the paint spray gun, that is, with the cover side pointing downward. The paint located in the fluid reservoir then flows downward into the paint inlet channel of the paint spray gun due to the force of gravity. Pressure equalization between the interior of the paint reservoir and the surroundings is necessary to allow the gravity-driven flow of paint. To guarantee this pressure equalization, a ventilation opening, which can be closed by means of an adhesive strip or a manually actuated valve, is formed in the container base.

Another fluid reservoir of this generic type is known from DE 10 2004 021 298 A1. For this fluid reservoir, the valve is constructed as a sliding valve for closing the ventilation opening. For such a sliding valve, there is the risk that the ventilation opening is not completely closed if the slider has not been completely pushed into the valve housing. In this case, there is the risk when filling the fluid reservoir with paint that paint will run out through the ventilation opening incompletely closed with the slide.

Starting with this state of the art, the invention is based on the task of presenting a fluid reservoir with a valve, easily actuated manually, for the reliable closing of the ventilation opening.

### SUMMARY OF THE INVENTION

This task is achieved with a fluid reservoir as set forth in the claims. Advantageous embodiments of this fluid reservoir are to be taken from the dependent claims.

### BRIEF DESCRIPTION OF THE DRAWINGS

The invention is explained in more detail below using an embodiment with reference to the enclosed drawings. The drawings show:

FIG. 1, a fluid reservoir according to the invention in section;

FIG. 2, detail view of the valve of the fluid reservoir of FIG. 1 in the closed valve position (FIG. 2a) and the open valve position (FIG. 2b);

FIG. 3, perspective detail views of the valve of the fluid reservoir of FIG. 1, in exploded representations viewed obliquely from above (FIG. 3a) or obliquely from below (FIG. 3b).

### DETAILED DESCRIPTION OF THE INVENTION

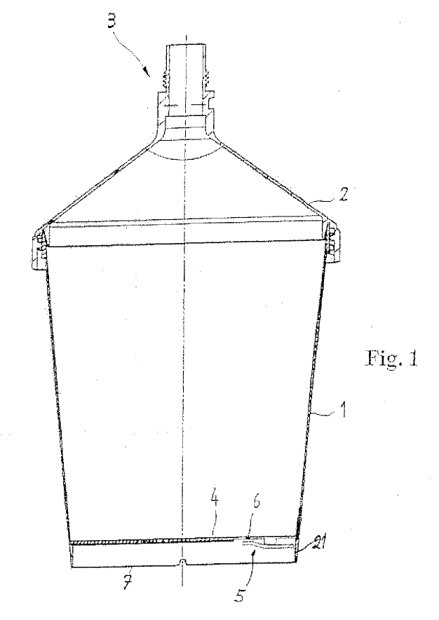

The fluid reservoir shown in FIG. 1 comprises a cup-shaped container 1 and a cover 2 that can be screwed onto this container by means of a thread. The cover 2 has an outlet port with an outlet opening on its top side. On the outside of the outlet port there is a connection part 3, which is used for the placement and attachment of the fluid reservoir on a paint spray gun or on an adapter arranged between the paint spray gun and the fluid reservoir. In the embodiment shown in FIG. 1, the connection part 3 comprises a thread and a wedge-shaped groove, which interact with corresponding connection parts on the paint spray gun, namely a corresponding internal thread and a pin for engaging in the groove. Both the container 1 and also the cover 2 are preferably constructed as injection-molded parts made from plastic.

For filling the container 1, the cover 2 is removed and then replaced after filling. Then the cover 2 is set and attached with its connection part 3 on the connection part of a paint spray gun or an adapter. During the spraying process, the fluid reservoir is located on the top side of the paint spray gun and the liquid in the container runs into the paint inlet channel of the paint spray gun due to the force of gravity.

To maintain the gravity-driven flow of the fluid, pressure equalization between the interior of the container 1 and the surroundings is necessary. For this reason, a ventilation opening 6 is provided in a wall 9 of the container 1. In the embodiment shown in the figures, the ventilation opening 6 is in the container base. Alternatively, however, the ventilation opening 6 can also be formed in the side wall of the container 1 preferably in the vicinity of the base. For closing the ventilation opening 6, a valve 5 is provided that is arranged on the bottom side of the container base. In addition, a surrounding cylindrical rim 21 is formed on the outer periphery on the bottom side of the container base. This rim projects beyond the valve 5, in order to be able to set down the container 1 on the base for filling.

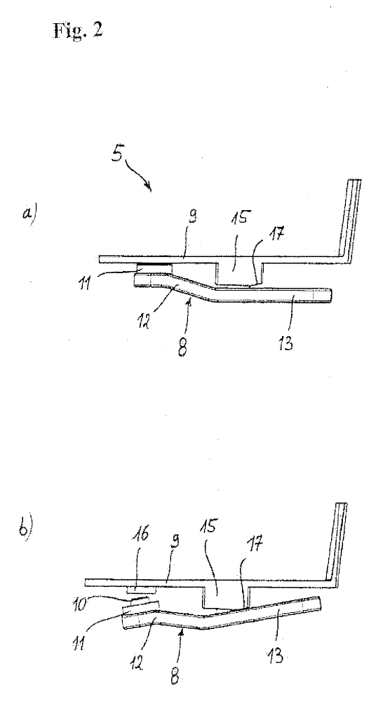

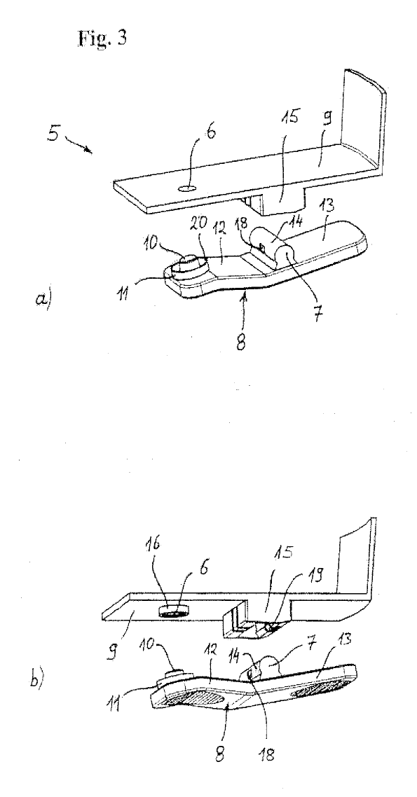

The valve 5 is constructed as a rocking valve and has a closing element 9 that can pivot about a pivot axis 7 for closing the ventilation opening 6. The valve 5 is shown in detail views in FIGS. 2 and 3 wherein FIG. 2a shows the valve 5 in the closed valve position and FIG. 2b shows it in the open valve position, and FIG. 3a and 3b show the components of valve 5 in the form of exploded views.

As can be seen from FIGS. 2 and 3, the valve 5 comprises a closing element 8, which can pivot about a pivot axis 7 like a rocker. The closing element 8 can pivot between a first valve position in which the closing element 8 closes the ventilation opening 6 (as shown in FIG. 2a), and a second valve position in which pressure equalization is allowed between the interior of the container 1 and the surroundings (as shown in FIG. 2b). In the first valve position, in which the closing element 8 closes the ventilation opening 6, the closing element 8 is preferably fixed in the ventilation opening 6 by means of a manually releasable gripping or latching mechanism.

The closing element 8 is composed of a first arm 12 and a second arm 13 and a pivot bearing 14 formed integrally on the bottom side of the closing element 8. The pivot bearing 14 has an essentially cylindrical shape and is clipped into a receiver bearing 15 integrally formed on the base of the container 1. The receiver bearing 15 is shaped so that the pivot bearing 14 can be detachably clipped or latched in the bearing. Alternatively, the closing element 8 can also be non-detachably attached, and thus captive, so that it can pivot on the receiver bearing 15 by means of the pivot bearing 14.

A plug 10 with a cylindrical form or tapering conically forward and arranged integrally on a plug plate 11 is constructed on the top side of the first arm 12 of the closing element 8. In the closed valve position (FIG. 2a) the plug 10 engages in the ventilation opening 6 and closes this in a fluid-tight way. Here, the plug plate 11, which is greater in diameter relative to the plug 10, rests on the outside of the wall 9 of container 1 in which the ventilation opening 6 is formed. A circular groove is formed in the plug plate, which preferably has a cylindrical construction just like the plug 10. In the closed valve position (FIG. 2a), a ring 16 formed around the ventilation opening 6 on the bottom side of the wall 9 and projecting from the wall 9 engages tightly in this groove. Through this gripping engagement of the ring 16 in the ring groove on the plug plate 11, a releasable fixing of the closing element 8 in the closed valve position and simultaneously a liquid-tight engagement of the plug 10 in the ventilation opening 6 is guaranteed. Preferably, the diameter of the plug 10 is matched to the diameter of the preferably circular ventilation opening 6, so that the plug 10 engages tightly in the ventilation opening 6, so that in this way a releasable fixing of the closing element 8 in the ventilation opening 6 for a closed valve position is also enabled. For this purpose, the diameter of the plug 10 is preferably tapered conically in the front.

In an alternative embodiment, the groove is wider in the plug plate 11 than the width of the ring 16. A gripping effect is then realized when the closing element is brought into the closed valve position. In this embodiment, the ring groove in the plug plate is used for retaining fluid that during the spraying process has possibly settled in the region around the ventilation opening and especially on the ring 16. In this embodiment, a peripheral surrounding collar 20, which surrounds the ring 16 in the closed valve position (FIG. 2a), is formed on the plug plate 11. The collar 20 acts as spatter protection when the ventilation opening 6 is closed by the closing element 8 and prevents the spattering of fluid or paint residue that has settled around the ventilation opening 6, and especially in the region of the ring 16, during the spraying process.

The valve 5 can be brought manually into the open valve position (FIG. 2b) from the closed valve position (FIG. 2a) through pressure on the second arm 13. With manual pressure on the second arm 13 of the closing element 8, the pivot bearing 14 pivots in the receiver bearing 15 by an angle of ca. 10 to 45°. To prevent excessive pivoting of the closing element 8, a stop is provided that in the embodiment shown in the figures is formed by an inclined surface 17 on the bottom side of the receiver bearing 15. The closing element 8 can be pivoted only so far by pressure on the second arm 13 until the top side of the second arm 13 contacts the inclined surface 17, as shown in FIG. 2b. For closing the ventilation opening, the closing element 8 can be brought into the closing position (FIG. 2a) through manual pressure on the first arm 12.

To be able to fix the closing element 8 both in the closed and also in the open valve position, catch elements 18, 19 corresponding to each other are preferably arranged on the pivot bearing 14 and on the receiver bearing 15. In the embodiment that can be taken from the drawings of FIGS. 3a and 3b, the catch elements 18, 19 are constructed in the form of recesses 18 in the pivot bearing 14 and catch tabs 19 corresponding to the recesses 18 on the receiver bearing 15. To be able to lock the closing element 8 both in the closed valve position and also in the open valve position on the receiver bearing 19, there are two recesses 18 in the pivot bearing 14 that lie on the outside of the semi-cylindrical pivot bearing 14 at opposing positions, and two corresponding catch tabs 19 on the receiver bearing 15.

In a preferred embodiment not shown here, a sealing ring is provided, which can be arranged either on the plug 10 or on the plug plate 11 or also in the ring 16, to guarantee the best possible fluid-tight closing of the ventilation opening 6.

1. Fluid reservoir for a paint spray gun with a container (1) and a cover (2) that is attachable on this container and has a connection part (3) to enable attaching the fluid reservoir on the paint spray gun or on an adapter, wherein the container (1) has a ventilation opening (6) that can be closed by means of a valve (5), characterized in that the valve (5) has a closing element (8) that can pivot like a rocker about a pivot axis (7) for liquid-tight closing of the ventilation opening (6).

2. Fluid reservoir according to claim 1, characterized in that the closing element (8) can pivot between a first valve position in which the closing element (8) closes the ventilation opening (6), and a second valve position in which pressure equalization is allowed between the interior of the container (1) and the surroundings.

3. Fluid reservoir according to claim 2, characterized in that the closing element (8) can be releasably fixed in the first valve position by means of a gripping or latching mechanism.

4. Fluid reservoir according to claim 1, characterized in that a plug (10), which engages in the ventilation opening (6) in the closed valve position, is formed on the closing element (8).

5. Fluid reservoir according to claim 4, characterized in that the plug (10) is arranged on a plug plate (11) that contacts the wall (9) of the container in which the ventilation opening (6) is formed when the plug (10) engages in the ventilation opening (6).

6. Fluid reservoir according to claim 1, characterized in that the closing element (8) is constructed as a rocker with a first arm (12), a second arm (13), and a pivot bearing (14).

7. Fluid reservoir according to claim 6, characterized in that the pivot bearing (14) is supported in a receiver bearing (15) arranged on the wall (9) of the container (1).

8. Fluid reservoir according to claim 7, characterized in that the receiver bearing (15) is integrally formed on the wall (9) of the container (1).

9. Fluid reservoir according to claim 7, characterized in that catch elements (18, 19) corresponding to each other are provided on the pivot bearing (14) and on the receiver bearing (15).

10. Fluid reservoir according to claim 9, characterized in that the pivot bearing (14) can be releasably latched on the receiver bearing (15), both in the first valve position and also in the second valve position, by means of the catch elements (18, 19) corresponding to each other.

11. Fluid reservoir according to claim 6, characterized in that the plug (10) is formed on the top side of the first arm (12) facing the wall (9).

12. Fluid reservoir according to claim 6, characterized in that the closing element (8) can be brought into the first valve position through manual pressure on the first arm (12) and from the first valve position into the second valve position through manual pressure on the second arm (13).

13. Fluid reservoir according to claim 5, characterized in that a ring (16) projecting outward and surrounding the ventilation opening (6) is formed on the wall (9), and that a peripheral surrounding collar (20), which surrounds the ring (16) in the first valve position, is formed on the plug plate (11).

14. Fluid reservoir according to claim 1, characterized in that the ventilation opening (6) is in the container base.

15. Fluid reservoir according to claim 1, characterized in that a seal is provided on the ventilation opening (6) or on the ring (16) surrounding this opening or on the closing element (8).
